(19) United States
(12) Patent Application Publication
(10) Pub. No.: US 2010/0102170 A1
(43) Pub. Date: Apr. 29, 2010

(54) ENERGY ABSORBING SEAT

(75) Inventor: Richard J. LaConte, Black Diamond, WA (US)

Correspondence Address: JENSEN + PUNTIGAM, P.S., 2033 6th Ave, Suite 1020, SEATTLE, WA, 98121, US

(73) Assignee: Harper Engineering Co., Renton, WA (US)

(21) Appl. No.: 12/260,650

(22) Filed: Oct. 29, 2008

(51) Int. Cl. B64D 25/04; B60R 21/02

(52) U.S. Cl. 244/122 R; 297/216.16

(57) ABSTRACT

A lightweight airplane seat using composite material to form a four-bar linkage, pivotal at the corners to reduce torque stresses and including a frangible compressible strut to absorb the forces generated during a crash.

### TECHNICAL FIELD

This invention relates to vehicle seats, and more particularly to energy absorbing seats for use in airplanes whereby, when the vehicle suddenly decelerates, a portion of the stress load that would normally be transferred to the floor is absorbed by the seat, reducing the trauma to the passenger and the chance of a seat breaking free.

### BACKGROUND OF THE INVENTION

The seats in a vehicle such as an airplane serve many purposes, some of which are immediately obvious, such as supporting a passenger in reasonable comfort. Other functions, such as restraining a passenger during an abrupt deceleration utilizing the framework and seat belts, as well as giving a passenger a defined place, but further, and less obvious, is that in the event of a crash, a passenger is more readily identifiable if located within his or her assigned seat. With this in mind, it is also equally important that the seats be retained as much as possible in their location and not be ripped off of or severed from the supporting floor.

In addition to the safety and comfort features, the airplane seat must be reduced in overall weight in order to keep the efficiency of the flight, enabling high load capability as well as reducing the overall cost to the consumer.

In addition to the above, it is desirable that the airplane seats absorb as much of the sudden deceleration forces as possible to reduce the stress on the supporting floor and increase the probability of the seat and supported passenger remaining attached and in the appropriate location.

Early attempts at making seats safer and more comfortable include U.S. Pat. No. 5,213,395 to Korteweg et al, issued May 25, 1993, which discloses an adjustable seat frame having energy-absorbing features.

U.S. Pat. No. 7,788,185 granted to Hooper on Aug. 4, 1998, discloses a feature used in aircraft seats, including the elasticity of the trailing legs, the seat pan and the seat cushion selected such that, in the event of a crash, a substantial portion of the load that would otherwise be imparted to a passenger's lower back is absorbed.

U.S. Pat. No. 5,794,911 granted to Hill on Aug. 18, 1998, discloses an adjustable vehicle seat suspension system.

U.S. Pat. No. 4,204,657 granted to Graham on May 27, 1980, discloses a life and weight-saving aircraft seat incorporating pneumatic seat and seat back cushions with pressure and temperature changes mediated by the provision of a predetermined pneumatic overflow envelope.

U.S. Pat. No. 6,505,890 granted to Riley et al on Jan. 14, 2003, discloses a passive restraint system utilizing a seat structure for the aircraft to store a source of pressurized gas to supply passenger airbags or the like.

U.S. Pat. No. 6,896,324 B1 granted to Kull et al on May 24, 2005, discloses a composite metal energy-absorbing seat including an energy-absorbing element placed on the lower seat pan to deform and absorb downward energy in a crash.

U.S. Pat. No. 7,185,867 B2 granted to Hill et al on Mar. 2, 2007, discloses a unique suspension arrangement for a vehicle seat, primarily an off-road vehicle seat to absorb the energy generated during an off-road ride.

U.S. Pat. No. 7,338,119 B2 granted to Burch on Mar. 4, 2008, discloses a seat back secured to a seat frame in hexagonally formed apertures and engaging hexagonally shaped connection members, such that relative rotation is restrained.

U.S. Publication No. US2007/0210635 A1 released on Sep. 13, 2007, discloses a four-bar linkage supporting a vehicle seat.

### SUMMARY OF THE INVENTION

With the above-noted prior art in mind, it is desirable to provide an airplane seat which is lighter in weight than those currently available, and yet has the ability to absorb the forces of inertia during a crash, while reducing the stress on the passenger as well as the stress or load on the floor of the airplane thus reducing the need for weight-increasing load reinforcement members.

It is further desirable to provide a lightweight airplane seat fabricated out of composite material, thus reducing the overall weight while addressing the known inability of the composite material to resist torque without shattering, while further absorbing the forces generated during rapid deceleration. The particular design is engineered such that the composite elements are subjected to only tension and compression forces.

### BRIEF DESCRIPTION OF THE DRAWINGS

FIG. 1 shows a typical airline seat configuration, although it does include the inventive support structure.

FIG. 2 discloses a currently existing seat support structure.

FIG. 3 depicts an alternative to the typical existing seat structure.

FIG. 4 depicts an alternative to the typical existing seat structure.

FIG. 5 is a schematic depiction of the present invention including the four-bar seat leg including an energy absorbing strut.

FIG. 6 shows the inventive four-bar seat frame supporting a seat, and indicating the center of rotation.

FIG. 7 is the same seat as FIG. 5, shown as the strut is compressed under a crash situation.

FIG. 8 is an existing seat leg showing the resulting forward load and upward and downward load as the result of a crash.

FIG. 9 is a figure similar to FIG. 7 indicating the reduced resulting loads utilizing the inventive energy support and seat support.

FIG. 10 is an illustration of a crash dummy in the inventive seat in a pre-crash condition.

FIG. 11 is an illustration of a crash dummy in the inventive seat in a crash condition.

### BEST MODE FOR CARRYING OUT THE INVENTION

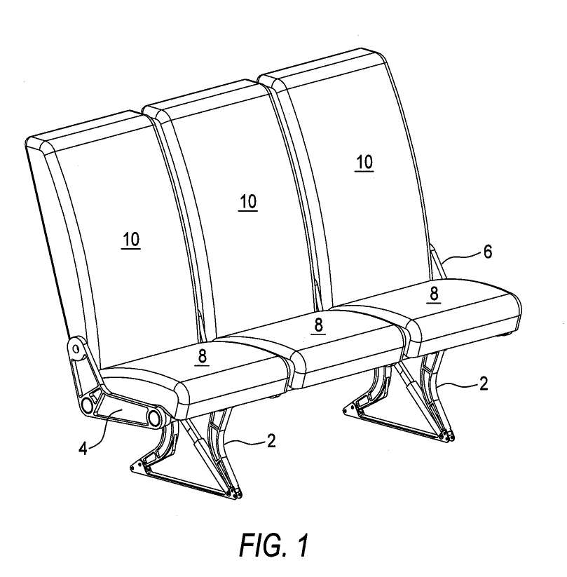

As seen in FIG. 1, a typical seat unit in an airline configuration includes a pair of legs 2 supporting a pair of parallel rods, not shown, to which are mounted end brackets 4, 6 which together support two or more seats which include the bottom cushion 8 and back cushion 10. It is to be noted that the legs 2, as shown in FIG. 1, are the inventive legs and will be described in greater detail hereinafter.

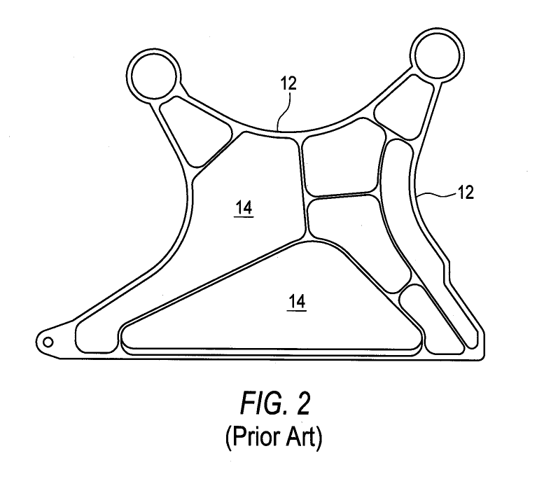

As seen in FIG. 2, the prior art seat leg is fabricated of cast aluminum or the like having rigid web portions 12 defining openings 14 to provide sufficient rigidity and reduced weight.

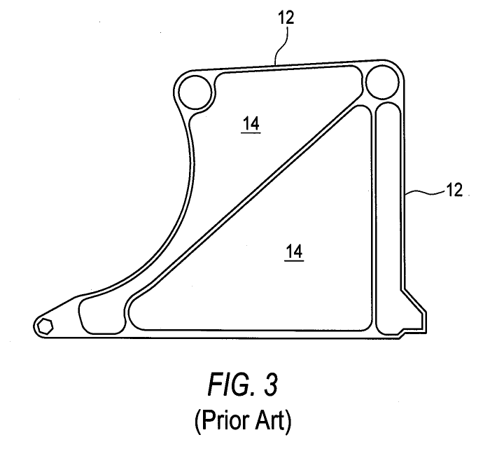

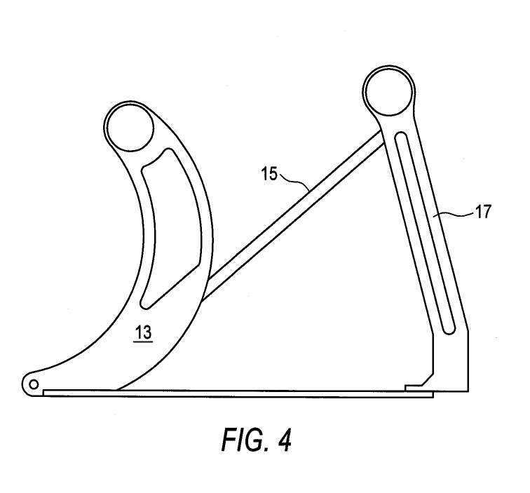

Likewise, as seen in FIGS. 3 and 4, the prior art device includes rigid web portions 12 and openings 14 or a multipiece including rigid elements 13, 45, 17.

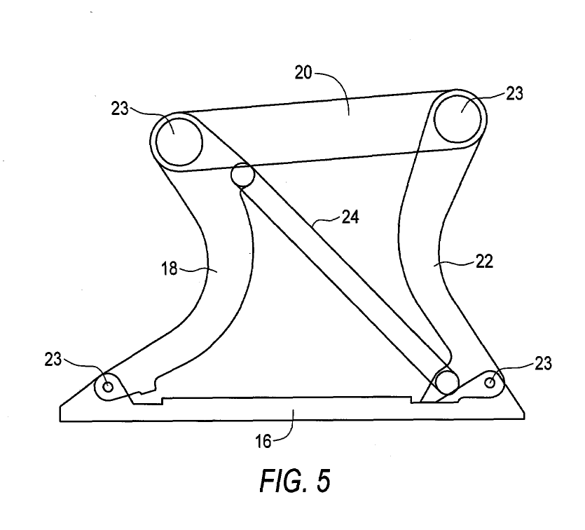

Reference is now had to FIG. 5, the inventive seat leg, wherein the four-bar seat leg is depicted in graphic form including the spreader 16, the rear or aft leg 18, the armrest frame 20 and the forward leg 22 which define the four bar. It is to be noted that the four bars are interconnected with pin joints 23 that are free to pivot but are rigidly coupled with a compression strut 24 that is frangible under a predetermined load and is the primary energy absorbing link.

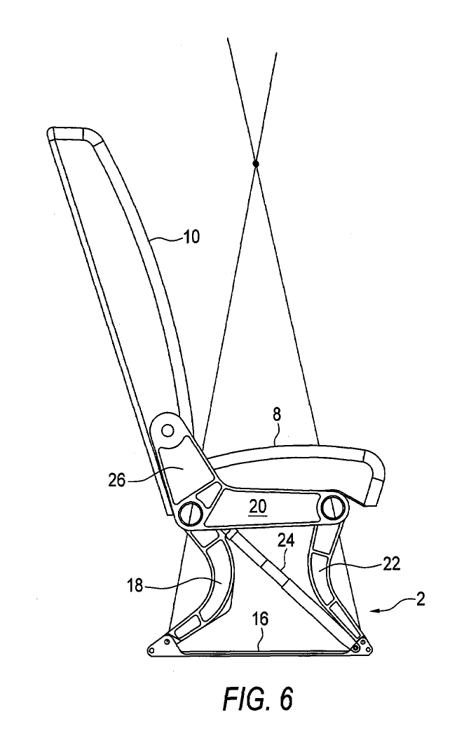

Reference is now had to FIG. 6, wherein the four-bar leg is shown in an actual seat configuration including the seat 8 and the backrest 10. It is to be noted that the support for the backrest 10 is actually an upward extension of the armrest frame 20 as seen at 26. Likewise shown in this view is the instantaneous center of rotation. It is to be noted that this configuration is the pre-crash configuration.

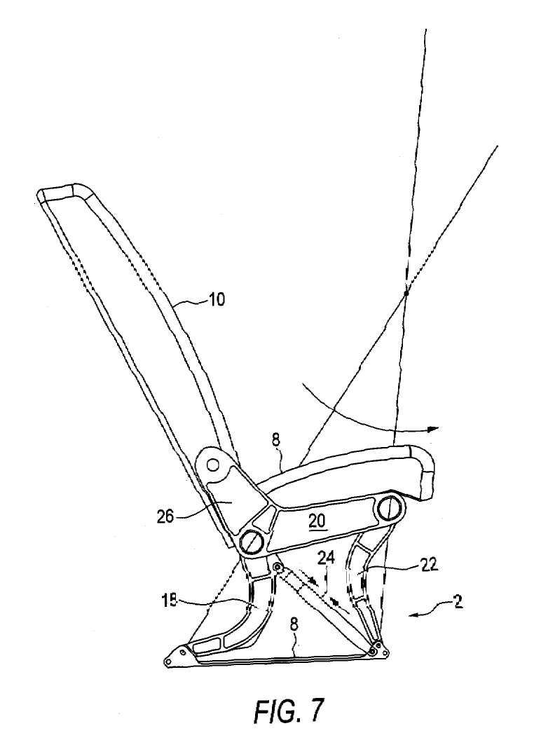

Reference is now had to FIG. 7, wherein a similar illustration is shown with the crash four-bar structure shown, and it is to be noted that the seat has rotated as the strut 24 compressed. The leg elements 18-24 are either in tension or compression.

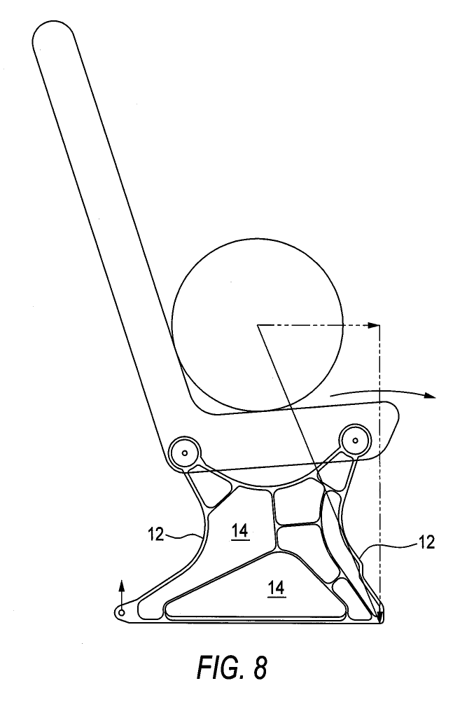

Reference is now had to FIG. 8, wherein the force vectors are shown regarding the seat mass and the resulting stress loads on the floor connection in a prior art structure.

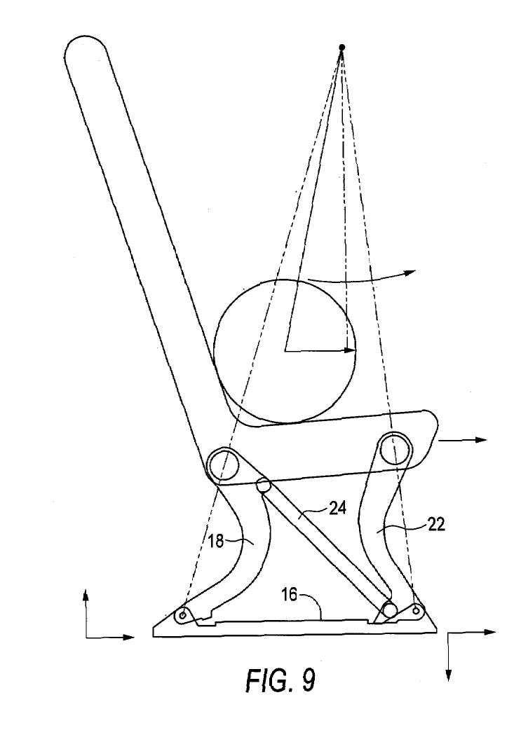

FIG. 9 is a similar illustration to FIG. 7, showing the force vectors of a crash situation with a four-bar seat load as is indicated wherein the crash energy is absorbed with the seat rotational motion and, therefore, the load is transferred to a forward or sheer load at the floor interconnection with a reduced download and reduced upload.

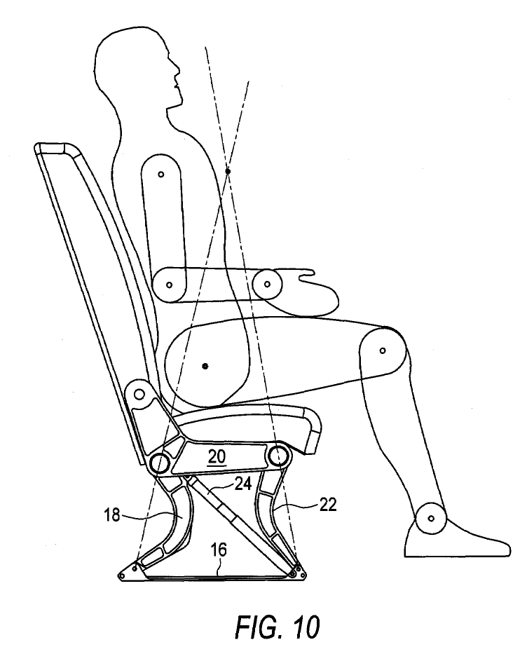

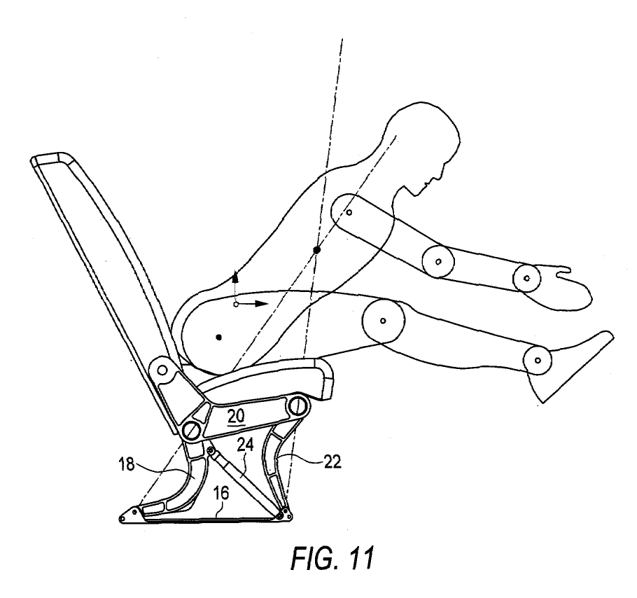

FIGS. 10 and 11 depict the invented four-bar leg including a seat and a crash dummy, in both a pre-crash condition and a crash condition illustrating the reaction of the compression strut.

As can be seen, the present invention provides a seat leg using composites which are subjected to torque loads without shattering, reducing the torque loads by absorbing the stresses in a compression strut resulting in a lighter-weight leg and greatly reduced up and down load on the floor, thereby greatly increasing the assurance that the seat and the passenger will remain in position during their crash.

Although a preferred embodiment of the invention has been disclosed herein for the purposes of illustration, it should be understood that various changes, modifications and substitutions may be incorporated in the embodiment without departing from the spirit of the invention, which is defined by the claims which follow.

What is claimed is:

1. A passenger seat for use in a moving vehicle comprising;
a four-bar link framework supporting the seat element; and
an energy absorbing strut extending from a lower front position of the framework in the direction the vehicle normally travels to an upper rear position of its framework such that when the vehicle rapidly reduces speed, the energy is absorbed in the strut as it collapses.

2. A seat as in claim 1, wherein the interconnection between the four bars is pivotal.

3. A seat as in claim 2, wherein the interconnections are a spherical bearing.

4. A seat as in claim 1, wherein the four-bar link is fabricated of a composite material.

5. A lightweight airplane seat using composite material to form a four-bar linkage, pivotal at the corners to reduce torque stresses; and
including a frangible compressible strut to absorb the forces generated during a crash.
